(19) United States
(12) Patent Application Publication
(10) Pub. No.: US 2006/0162552 A1
(43) Pub. Date: Jul. 27, 2006

(54) Systems and methods for controlling room air quality

(75) Inventors: John W. Yost, Bennington, VT (US); Rocco N. Irish, Pattersonville, NY (US)

Correspondence Address: HESLIN ROTHENBERG FARLEY & MESITI PC, 5 COLUMBIA CIRCLE, ALBANY, NY, 12203, US

(73) Assignee: Mohawk Valley Energy Solutions, Inc., Schenectady, NY (US)

(21) Appl. No.: 11/043,569

(22) Filed: Jan. 26, 2005

(51) Int. Cl. B01D 46/46

(52) U.S. Cl. 95/1

(57) ABSTRACT

Systems and methods for improving the air quality of living spaces are provided. These systems and methods utilize improved filtration media and electronic control of the speed of the air handler to minimize the presence of contaminants in the air while optimizing the efficiency of the operation to the air handler. In one aspect, the speed of the air-handling device is controlled in response to the concentration of a contaminant in the living space. In another aspect, the speed of the air-handling device is controlled to optimize the filtration efficiency of the filtering medium. The systems and methods disclosed may be used in residential, commercial, and industrial settings, for example, in hotel rooms as well as for an entire home.

### TECHNICAL FIELD OF THE INVENTION

The present invention generally relates to systems and methods for controlling the quality of air in a room. More particularly, the present invention relates to system having an air filter, an air handler, and means for controlling the speed of the air handler to optimize the air quality and minimize energy consumption.

### BACKGROUND OF THE INVENTION

Internal air quality is an ever increasing concern for residential, commercial, and industrial buildings. The minimization or elimination of contaminants, for example, cigarette smoke, pollen, mold, and mildew, among others, is a continual concern for home owners, restaurant owners, hotel, resort, casino, office buildings, and the like is often critical to the occupants of internal spaces.

Prior art systems for removing impurities from air typically include some form of filtering medium and an air handling device, such as a fan, for drawing air through or forcing air through the medium. Such existing systems may typically be associated with a heating system or a cooling system that are operated either continuously or intermittently, for example, in response to a demand from a thermostat for a higher or lower temperature in an internal space, such as a hotel room. In addition, such prior art systems typically do not and cannot regulate the operation of the air handing to optimize the efficiency of the contaminant removal or the efficiency of the air handler. For example, existing systems may be operated intermittently to provide a desired nominal temperature within a room and then turned off when the nominal temperature is achieved. In other prior art systems, the air handler may be operated continuously with no regulation of the speed of operation of the air handler.

In addition, existing systems typically are not regulated based upon the level of contamination in the internal space and are not operated to optimize the performance of the filtering medium. For example, the air may be passed through a filtering medium when no filtering is necessary or air may be passed through the filtering medium under conditions where filtering is suboptimal, for example, at a “face velocity” above or below the optimal face velocity of the filtering medium.

Aspects of the present invention over come these and other limitations of the prior art by providing filtering systems that optimize the removal of contaminants and/or optimize the efficiency of operation of the air handler.

### SUMMARY OF ASPECTS OF THE INVENTION

Aspects of the present invention combine the benefits of advanced filtration technology with advanced electronic control technology to provide air filtration systems that exceed the performance of prior art air filtration systems. One aspect of the invention is a method for providing a predetermined air quality in an internal space, the method using an air handling system including an air moving device having an inlet in fluid communication with the air in the internal space and an outlet; a filtering element adapted to remove at least one contaminant from an air flow passing through the filtering element; and means for controlling the operation of the air moving device; the method including operating the air moving device to extract air from the internal space; passing the extracted air through the filtering element to remove at least one contaminant from the extracted air; returning the extracted filtered air to the internal space; and controlling the speed of the air moving device to minimize the speed of the air moving device while maintaining the predetermined air quality in the internal space.

Another aspect of the invention is a system for providing a predetermined air quality in an internal space, the system including an air-moving device having an inlet in fluid communication with air in the internal space and an outlet in fluid communication with the internal space; a filtering element adapted to remove at least one contaminant from an air flow passing through the filtering element, the filtering element in fluid communication with one of the inlet and the outlet of the air moving device; a speed controller adapted to control the speed of the air moving device to minimize the speed of the air moving device while maintaining the predetermined air quality in the internal space.

Another aspect of the invention is a method for filtering at least one contaminant from air in a room, the method using an air handling system including an air moving device comprising one of a fan and a blower, the air moving device having an inlet in fluid communication with the air in the room and an outlet; a non-ionizing, polarized filtering element adapted to remove at least one contaminant from an air flow passing through the filtering element; a fresh air intake operatively connected to the inlet of the air moving device, the fresh air intake providing a fresh air flow; and an automated controller for controlling the speed of operation of the air moving device; the method including operating the air moving device to extract air from the room; passing the extracted air through the filtering element to remove at least one contaminant from the extracted air; drawing the fresh air flow into the system; returning the filtered extracted air and fresh air flow to the room; and controlling the speed of the air moving device to minimize the speed of the air moving device and minimizing the amount of fresh air flow introduced to the system.

A still further aspect of the invention is a system for filtering at least one contaminant from air in a room, the system including a filtering element adapted to remove at least one contaminant from a flow of air passing through the filtering element; an air moving device adapted to draw at least some air from the room and pass the air through the filtering element; and means for controlling the operation of the air moving device to vary the flow of the air through the filtering element to optimize the removal of the at least one contaminant from the flow of air.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic diagram of a system for controlling the air quality in a room according to one aspect of the present invention.

FIG. 2 is a perspective view of a stand-alone air-cleaning device according to one aspect of the invention.

FIG. 3 is a side elevation view, partially in cross-section, of the air-cleaning device shown in FIG. 2.

FIG. 4 is a cross-sectional view of the air-cleaning device shown in FIG. 3 as viewed along lines 4-4 in FIG. 3.

FIG. 5 is a schematic diagram of the wiring of the air-cleaning device shown in FIG. 3 according to one aspect of the invention.

### DETAILED DESCRIPTION OF ASPECTS OF THE INVENTION

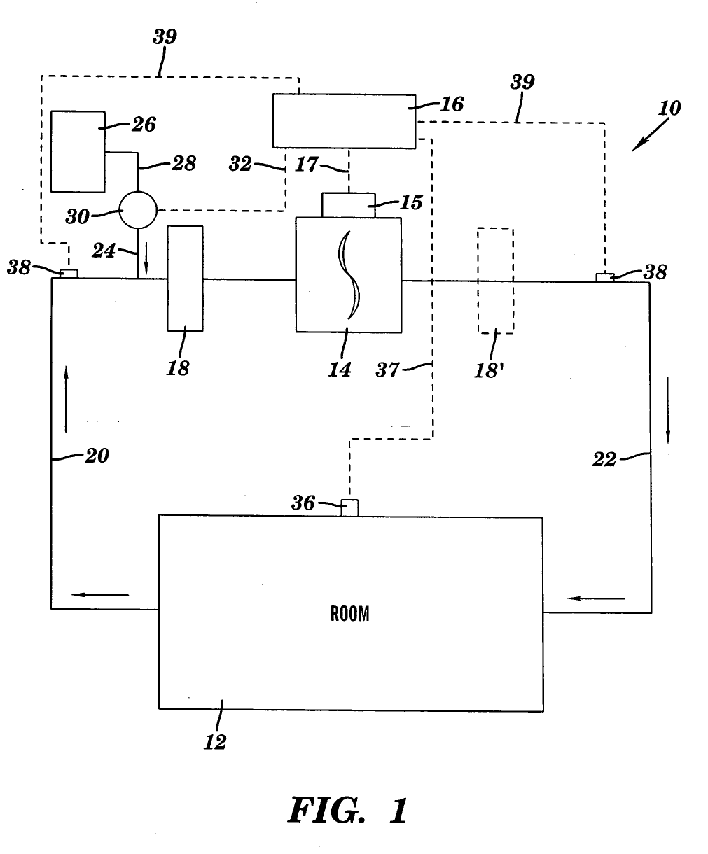

FIG. 1 is a schematic diagram of a system 10 for controlling the air quality in a room 12 according to one aspect of the present invention. Room 12 may be any internal space adapted for human habitation that may require a circulation of air, for example, for filtration, heating, or cooling. System 10 includes an air handler or air moving device 14, an air handler controller 16, one or more filtering elements 18, and appropriate conduits adapted to transfer air from room 12 to system 10. According to aspects of the invention, air handler 14 draws air from room 12 via one or more conduits 20 and returns treated air, for example, filtered air, to room 12 via one or more conduits 22. Though not shown in FIG. 1, system 10 may include a heating device or a cooling device, that is, an “air conditioner,” for heating or cooling the air passing through system 10, as appropriate. System 10 may be a system marketed under the name Energy Saving Air Cleaner™ (ESAC™) System by Mohawk Valley Energy Solutions of Schenectady, N.Y.

According to the present invention, air handler 14 may be a fan, a blower, or a pump, among other air handling or air moving devices. Air handler 14 typically is sized and configured to transfer air from and to room 12 to provide the desired air quality in room 12, for example, provide an air flow of at least 750 cubic feet per minute (CFM). In one aspect of the invention, air handler 14 comprises a unit ventilator, for example, a model number VUVC075010 provided by Trane, or its equivalent. According to one aspect of the invention, air handler 14 includes a motor 15 operatively connected to the air mover, for example, to the fan blade shaft. The speed of motor 15, and thus the speed of the air mover, is controlled by air handler controller 16. In one aspect of the invention, motor 15 may be a fractional-horsepower single-phase motor, for example, a ⅓-Hp, 110 volt, Dayton motor having a model number 4048 provided by W.W. Grainger Inc., or its equivalent.

Filter element, or simply “filter,” 18 may comprise any device adapted to remove at least one contaminant from the flow of air introduced to filter 18 via conduit 20. One or more filters 18 may be positioned upstream of air handler 14 as shown in FIG. 1, or down stream of air handler 14 as indicated by filter 18′ (shown in phantom). According to one aspect of the invention, air handler 14 may draw air from room 12 through one or more filters 18 and/or propel air through one or more filters 18′. In one aspect of the invention filter 18 may comprise a Dynamic Air Cleaner (DAC) filter for example, a 42-inch×72-inch Model P1000 Filter supplied by Dynamic Air Cleaner though equivalent filters may be used.

According to one aspect, air handler controller, or simply “controller,” 16 is adapted to control the speed of operation of air handler 14, for example, control the speed of fan rotation when air handler 14 is a fan, or control the speed of impeller rotation when air handler 14 is a blower or pump. In one aspect of the invention, controller 16 may comprise a controller adapted to control the speed of motor 15 of air handler 14 wirelessly or via electrical connection 17. The electrical signal passing over connection 17 may be analog or digital electrical signals, for example, a 4 to 20 milliAmp (mA) signal. In one aspect, controller 16 may at least intermittently control the speed of motor 14; according to another aspect, controller 16 may substantially continuously control the speed of motor 14, for example, 24 hours per day. In one aspect of the invention, controller 16 allows the use of ‘over-sized’ fans operated at lower speeds.

In one aspect of the invention, controller 14 may be a variable speed controller, for example, a Model PS-2000 variable speed controller supplied by Intelligent Power Management Corporation (IPM) of Utica, N.Y., though other types of variable speed controllers may be used.

A fresh air intake 24 may also be provided to system 10. Fresh air intake 24 may be operatively connected to a source of fresh air 26, for example, outside ambient air, via one or more conduits 28. The control of fresh airflow may be regulated by means of valve, damper, or baffle 30. The operation or position of valve, damper, or baffle 30 may be controlled manually or by means of controller 16. The control signal may be transmitted wirelessly or via a control signal transmitted over electrical connection 32, for example, a 4 to 20 mA signal. In one aspect of the invention, valve, damper, or baffle 30 may be a motorized damper, for example, a motorized damper having a model number FSA-100-14 provided by Phillips-aire of Holland, Ohio, though equivalent dampers may be used.

System 10 may also include one or more sensors. For example, in one aspect of the invention, at least one sensor 36 may be positioned to detect one or more conditions within room 12. Sensor 36 may be positioned anywhere in room 12 where it can be exposed to the air in room 12. For example, sensor 36 may be adapted to detect the concentration of one or more gases or contaminants in room 12, the temperature in room 12, or the air pressure in room 12, among other parameters. For example, sensor 36 may be an oxygen (O₂) sensor, an ozone (O₃) sensor, a carbon dioxide (CO₂) sensor, a carbon monoxide (CO) sensor, a propane gas sensor, volatile organic compound (VOC) sensor, and the like. A signal corresponding to the detected condition may be transmitted from sensor 36 to controller 16 wirelessly or via an electrical connection 37, for example, a 4-20 mA signal. In one aspect of the invention, system 10 may also include at least one sensor 38 positioned to detect one or more conditions within conduit 20 and/or conduit 22. For example, sensor 38 may be adapted to detect the concentration of one or more contaminants, the temperature, or the air pressure, among other parameters, in conduit 20 and/or 22. A signal corresponding to the detected condition may be transmitted from sensor 38 to controller 16 wirelessly or via an electrical connection 39, for example, by means of a 4-20 mA signal.

Room 12 may be any internal space for which air cleaning or purification is desired. For example, room 12 may be residential room, for example, a bedroom or living room, or the entire home, among others; a commercial room, for example, a restaurant, a bar, a lounge, an office, a hotel room, or a hospital room, among others; an industrial room, for example, a clean room, a shop floor, a warehouse, or a computer room, among others; or a school room or church, among others.

According to aspects of the present invention, controller 16 and filter 18 are adapted to maximize air purification while minimizing energy consumption by motor 15 and air handler 14. In one aspect, filter 18 may be a high efficiency filter capable of removing contaminants from the stream of air passing through it. For example, contaminants such as cigarette smoke, pollen, mold, mildew, viruses, bacteria, and other common irritants can be removed by filter 18. In one aspect of the invention, filter 18 also removes odors from the air, for example, the odors associated with one or more of the contaminants listed above, for instance, the odors associated with cigarette smoke. In one aspect of the invention, filter 18 may be a non-ionizing, polarized media air filtration device. Such a filtration device uses very low voltage (for example, 24V, and less than 2 VAC) electrical charge to impose a voltage, for example, a high voltage, across a fibrous media within a grounded frame. The resulting filtration capability far exceeds the filtration capability of conventional filter media. In one aspect of the invention, filter 18 may have very low air pressure drop, for example, a pressure drop of only about 2 inches of water, gauge, (w.g.) at an airflow of about 300 fpm. In one aspect, filter 18 may be a filter having a replaceable filter medium, for example, an inexpensive replacement medium compared to other filters, for example, compared to ‘passive’ (95% cartridge) filters with similar air cleaning performance. In one aspect of the invention, the performance of filter 18 may be superior to other electronic air cleaners with respect to filtration effectiveness, flexibility of application, quiet operation, and replaceable media configuration (for convenience of operation and product longevity). In one aspect, filter 18 comprises a filtration medium or panel having a thickness of about 1 inch or about 2 inches.

In one aspect of the invention, system 10 may be adapted to control the presence or concentration of odors in room 12, for example, as indicated by the presence or absence of volatile organic compounds (VOCs) in the air in room 12. For example, in one aspect of the invention, system 10 may be adapted to eliminate odors, for example, undesirable odors, such as those odors typically encountered in health facilities, for example, hospitals, emergency rooms, nursing homes, and independent or assistive living facilities.

In one aspect of the invention, controller 16 may be operated to optimize the speed of the airflow through filter element 18 to obtain optimum air purification. For example, filter 18 may comprise an optimum velocity for optimum filtration, for example, filter 18 may have an optimum “face velocity,” that is, a velocity substantially across the cross section of the filter medium. For example, in one aspect of the invention, an optimum face velocity for a 1-inch thick filter medium may be about 150 feet per minute (fpm) or lower. In another aspect, the optimum face velocity for filter 18 having a 2-inch thick filter medium may be about 350 fpm or lower. In one aspect of the invention, for example, where biological contaminants may be present in the air stream, an ultraviolet (UV) light source may be incorporated with or into filter 18 to kill at least some biological contaminants.

In one aspect of the invention, filter 18 comprises a non-ionizing, polarized media filtration device that may be effective for eliminating contaminants and odors from the flow of air passing through it. In one aspect, filter 18 comprises a device that generates little or no ozone, for example, in contrast to some prior art electronic air cleaners that emit ozone, a known carcinogen. In one aspect of the invention, filter 18 emits little or no noise, for example, operates substantially silently, especially compared to prior art air cleaners that emit a characteristic popping or snapping noise during operation. In one aspect, the pressure drop across filter 18 is comparatively low, for example, less than 2 inches w.g., which contributes to a typical quiet operation. In another aspect of the invention, the filter medium of filter 18 may be a relatively low cost medium, for example, a medium made from recycled materials, such as, recycled glass fiber.

In one aspect of the invention, controller 16 is adapted to provide active speed modulation of the speed of motor 15, for example, a fractional-horsepower single-phase motor. In contrast to rheostat-type controllers, for example, typical of conventional residential dimmer switches, controller 16 may reduce the electrical power consumption of motor 15 under partial load operation.

According to aspects of the invention, the speed of motor 15 may be controlled by controller 16 based upon a variety of functions. For example, in one aspect of the invention, controller 16 may allow the use of low-speed air handler 14, for example, low speed fans, to provide for quiet and low-power consuming operation and, for example, promote extended product life. According to another aspect of the invention, controller 16 may continually modulate the speed of air handler 14 and thus minimize the electrical power necessary while generating minimum noise. Aspects of the present invention also may adapt to varying room conditions, for example, varying contaminant concentrations. For example, controller 16 may regulate the speed of motor 15 in response to a condition in room 12 or a condition in conduits 20 and/or 22, for example, as detected by sensors 36 and/or 38 and transmitted to controller 36 wirelessly or via electrical connections 37 and 39, respectively. In one aspect, the condition detected by sensor 36 and/or 38 may be the concentration of one or more contaminants in room 12 or conduits 20 and/or 22; the temperature in room 12 or conduits 20 and/or 22; or the pressure in room 12 or conduits 20 and/or 22, among other conditions.

In another aspect of the invention, controller 16 may be adapted to set-up and balance the air flows in conduit 20 and/or 22 to ensure a substantially constant, for example, desired, airflow at least some time or substantially all times. In one aspect, controller 16 may automatically adapt the speed of motor 15 to changes in air resistance through a duct of filter to maintain a desired airflow. For example, in one aspect, system 10 may also include a sensor adapted to sense the pressure drop across filter 18 and to control the operation of air handler 14 accordingly. For example, controller 18 may automatically adapt to a change in differential pressure across filter 18, for instance, an increase in pressure drop that may be indicative of a filter or filter medium that has become damaged, clogged, or otherwise in need of servicing or replacement. In one aspect, controller 16 may maintain the desired airflow through the life cycle of the filter medium. In one aspect, controller 16 may reduce the power consumption of motor 16, for example, at part-load operation.

According to aspects of the present invention, system 10 provides a combination of energy conservation and improved filtration compared to prior art system. For example, in one aspect, the interaction of the benefits of controller 16 and filter 18 provide an improved air filtration system, that is, a synergistic interaction providing an improved outcome that would not have been predicted from an individual consideration of the capabilities of controller 16 and filter 18.

The improved benefits of system 10 are illustrated by considering the typical operation of convention air filtration systems. Conventional air filtration systems may include an air handler, a controller for controlling the speed of operation of the air handler, and a filter medium. In contrast to the present invention, in the existing art, a desired airflow of the filtration system may be defined by existing standards for the size and use of the room from which air will be filtered, for example, standards established by the American Society of Heating, Refrigeration, and Air-conditioning Engineers (ASHRAE). Typically, such standards specify a minimum airflow that must be provided by the air handling system, for example, a minimum airflow of about 15 cubic feet per minute (cfm) per person occupying the room. Based upon this minimum air flow, the filtration system is typically provided with an oversized air handler, for example, at least 15% oversized, and an oversized filter medium, for example, at least 10% oversized, to ensure that the minimum air flow requirements will be provided for the substantially the life of the system. This is due, among other things, to the unknown variation in operating conditions and loads that may occur, for example, the presence of an unexpected undesirable odor, an overcapacity of human occupancy, or a blockage in the ductwork or filter medium, among other things. However, such an oversized air handler typically provides an inefficient use of energy, consumes a larger amount of space, and emits excess noise compared to a system that is optimally sized for the room size and desired air quality. In addition, such air handlers are typically provided with controllers having a limited and discrete speed settings, often simply, maximum speed and off. These and other disadvantages of existing systems are overcome by aspects of the present invention.

In one aspect of the invention, a filter 18 having an improved filter medium is provided. Compared to other prior art filters, filter 18 provides a markedly improved capacity to remove contaminants. In one aspect of the invention, filter 18 comprises a P-1000 dynamic filter provided by Dynamic Air Cleaner. In one aspect of the invention, filter 18 has an optimum face velocity for removing contaminants from the airflow passing through it. However, according to the prior art practice, providing air handlers of limited or discrete speed control settings does not allow the filter to operate at or near the optimum face velocities of the filter. According to one aspect of the invention, controller 16 may be adapted to regulate the flow of air through filter 18 whereby the airflow through filter 18 is about the optimum face velocity of the filter whereby optimum contamination removal is provided. In one aspect of the invention, the controller 16 substantially continuously regulates the flow of air through filer 18 to optimize the removal of contaminants.

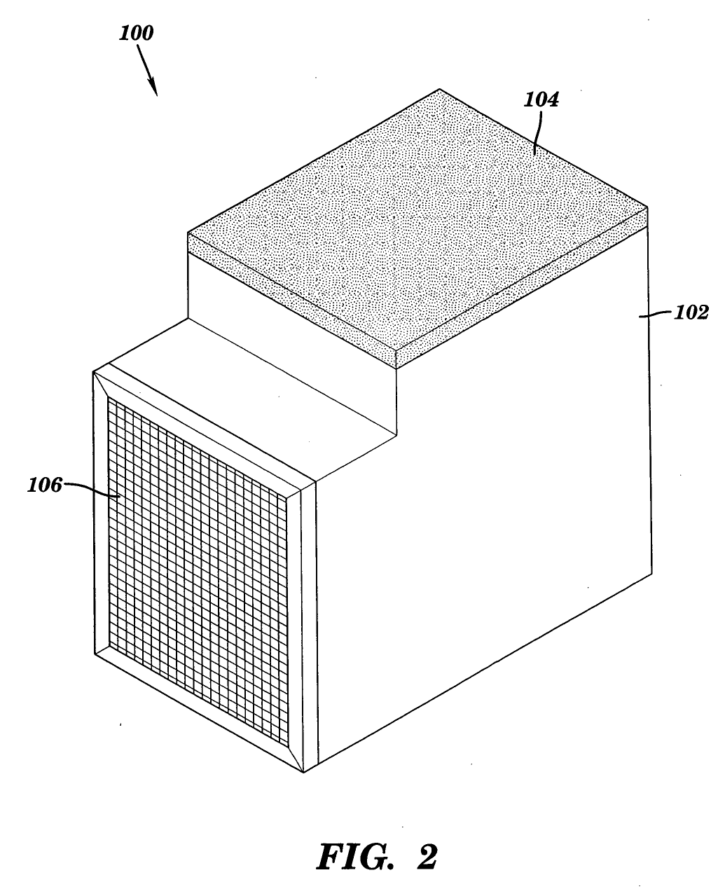

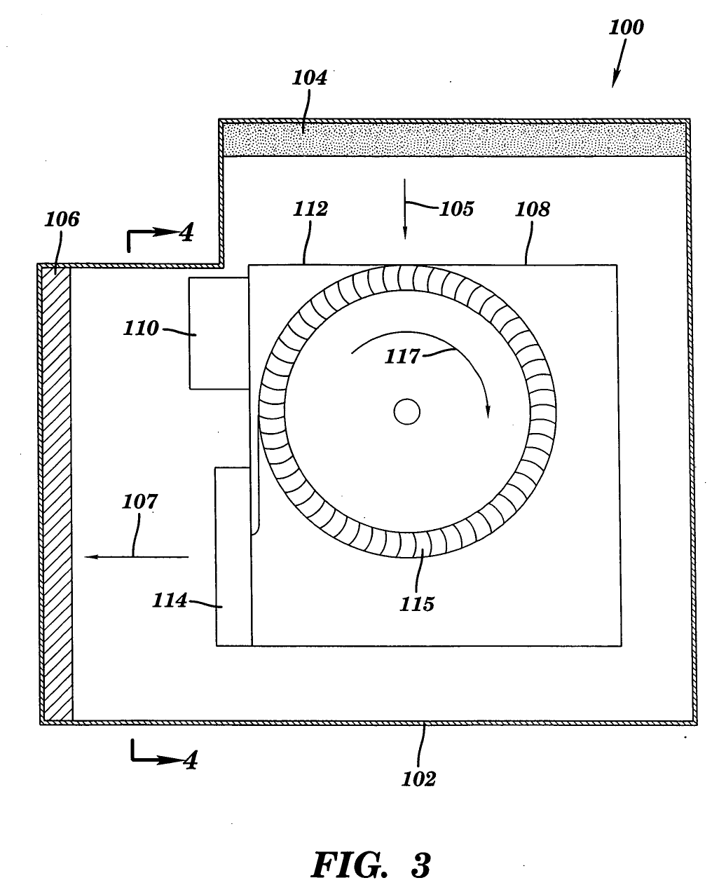

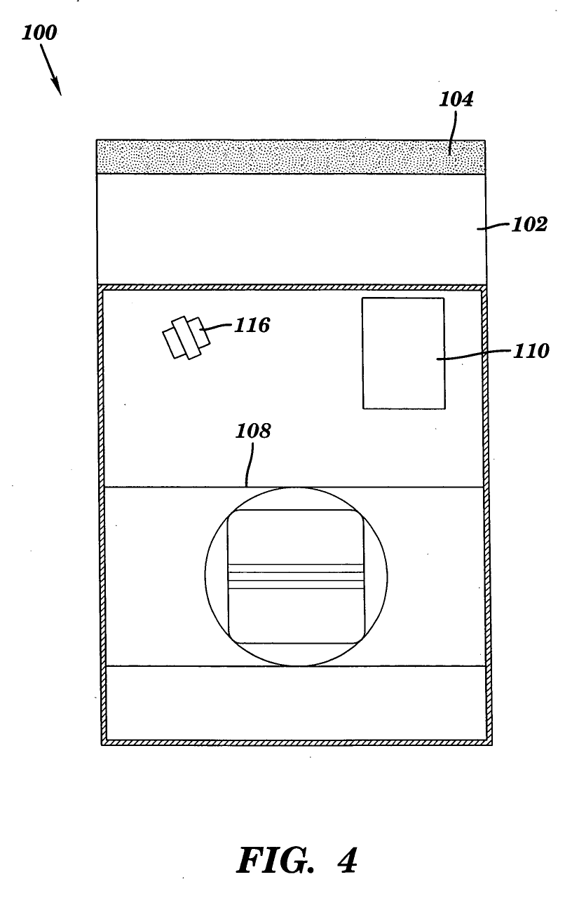

Though aspect of the invention may include systems designed for use with given internal spaces having a given filtering requirement, aspects of the invention also include stand-lone units, for example, portable stand-alone units that may be operated as need in an internal space. FIG. 2 is a perspective view of a stand-alone air-cleaning device 100 according to one aspect of the invention. FIG. 3 is a side elevation view, partially in cross-section, of air-cleaning device 100 shown in FIG. 2. FIG. 4 is a cross-sectional view of air-cleaning device 100 shown in FIG. 3 as viewed along lines 4-4 in FIG. 3. Device 100 typically comprises a housing 102 defining an air intake adapted to retain a filter element 104 and an exhaust having an air-permeable protective barrier 106, for example, a grille. As shown in FIGS. 3 and 4, device 100 typically includes an air-moving device 108, for example, a fan, and an air-moving device controller 110 adapted to control the operation of air-moving device 108. In one aspect of the invention, air moving device 108 may be adapted to draw air through filter element 104, as indicated by arrow 105, and discharge filtered air through barrier 106, as indicated by arrow 107. For example, in one aspect of the invention, air-moving device 108 may include an intake 112 and an exhaust 114. In another aspect of the invention, air-moving device 108 may be adapted to draw air through barrier 106 and discharge air through filter element 104. Though in the aspect of the invention shown in FIGS. 3 and 4 air is taken in through filtering element 104 positioned in the top of housing 102, that is, above air-moving device 108, and discharged out a barrier 106 positioned on the side of housing 102, the intake and exhaust of air by device 100 may be practiced through any side of housing 102. For example, in one aspect of the invention, the positions of filter element 104 and barrier 106 may be reversed where air is drawn in through barrier 106 and discharged out filtering element 104.

According to one aspect of the invention, air-moving device controller 110 may be adapted to control the operation of the air-moving device 108 to optimize the removal of contaminants from the flow of air passing through device 100. For example, as discussed with respect to FIG. 1, controller 110 may be adapted to control the operation of air-moving device 108 in response to a sensor, for example, in response to a sensor adapted to detect an environmental condition of the air handled by device 100. In one aspect of the invention, device 100 may include at least one environmental sensor, for example, a sensor mounted to housing 102 and adapted to detect an environmental condition of the air adjacent to housing 102.

In one aspect of the invention, filter element 104 may be an electrically energized or electrically charged filter element, for example, a filter element adapted to operate with an electric field. In this aspect of the invention, device 100 may include at least one electric power transformer 116, for example, a 10-kVA Dormeyer transformer, provided by Saia-Burgess Electronics of Vernon Hills, Ill., or its equivalent, that is adapted to convert the voltage provided to the transformer to a voltage at which filter element 104 operates effectively. Transformer 116 may be mounted to housing 102 or to the housing of air-moving device 108.

Air-moving device 108 may be any device that is adapted to draw air into housing 102 and propel air out of housing 102. For example, in one aspect, air-moving device 108 may be a blower or a fan, for instance, a squirrel-cage fan having an impeller 115 which rotates in the direction indicated by arrow 117 in FIG. 3. Air moving device 108 may be a Dayton squirrel-cage fan having a model number 4C 592B provided by W.W. Grainger Inc., though other types of blowers or fans may be used. Similarly, air-moving device controller 110 may be any controller adapted to control an air-moving device, for example, adapted to control a motor which drives air-moving device 108. In one aspect of the invention, controller 110 may be a controller provided by Intelligent Power Management Corporation, for example, a model PS-2000 controller, or its equivalent.

As disclosed with respect to system 10 shown in FIG. 1, according to aspects of the invention, controller 110 may be operated to optimize the speed of the airflow through filter element 104 to obtain optimum air purification. That is, device 100 may be operated to provide an optimum air velocity for optimum filtration, for example, an optimum “face velocity”. For example, in one aspect of the invention, an optimum face velocity for a 1-inch thick filter element 104 may be about 150 fpm or lower. In another aspect, the optimum face velocity for filter element 104 having a 2-inch thick filter medium may be about 350 fpm or lower. In one aspect of the invention, for example, where biological contaminants may be present in the air stream, an ultraviolet (UV) light source may be incorporated with or into filter device 100 to kill at least some biological contaminants.

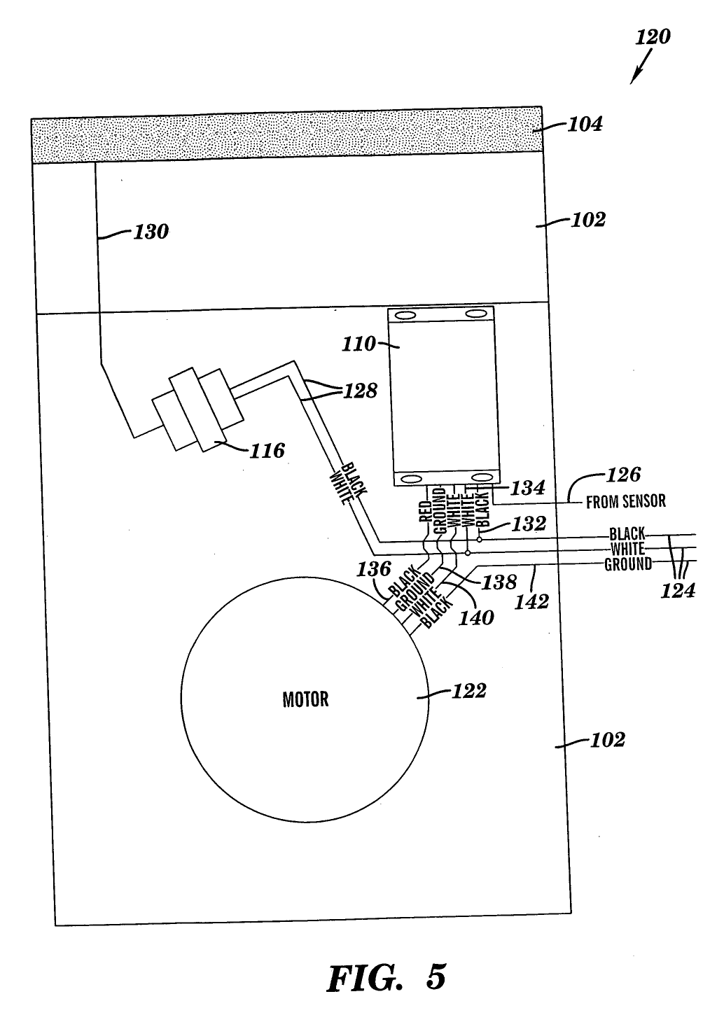

FIG. 5 is a schematic diagram 120 of the wiring of the air-cleaning device 100 shown in FIG. 3 according to one aspect of the invention. Schematic diagram 120 includes a schematic of a motor 122, for example, a motor that drives air-moving device 108 in FIGS. 3 and 4, controller 110 and transformer 116. As shown in FIG. 5, motor 122 and controller 110 may be powered by a three-conductor electrical wire 124, and controller 110 may receive a control signal, for example, from a remote environmental sensor, via wire 126. Three-conductor wire 124 may typically provide conventional 120 VAC, for example, from a wall-mounted electrical outlet. In addition, transformer 116 may be powered by a two-conductor electrical wire 128 which may be adapted to provide an electrical signal via wire 130, for example, a 6,500 VDC signal, to filter element 104. In the aspect of the invention shown in FIG. 5, controller 110 receives power from three-conductor wire 124 via wires 132 and 134. As shown, controller 110 may power motor 122 via one or more wires 136, 138, and 140, for example, in response to a control signal received via wire 126. Motor 122 may also be grounded, for example, grounded to wire 124 via wire 142. FIG. 5 illustrates one means of wiring aspects of the present invention. Other wiring designs to provide aspects of the present invention as will be apparent to those of skill in the art.

Aspects of the present invention provide improved air cleaning capability compared to prior art systems and methods. In one aspect of the invention, less electrical power is consumed for a comparable filtering than prior art systems and methods. In another aspect of the invention, the noise of the fan and motor are reduced compared to prior art systems and methods.

While several aspects of the present invention have been described and depicted herein, alternative aspects may be provided by those skilled in the art to accomplish the same objectives. Accordingly, it is intended by the appended claims to cover all such alternative aspects as fall within the true spirit and scope of the invention.

We claim:

1. A method for providing a predetermined air quality in an internal space, the method using an air handling system comprising:
an air moving device having an inlet in fluid communication with the air in the internal space and an outlet;
a filtering element adapted to remove at least one contaminant from an air flow passing through the filtering element; and
means for controlling the operation of the air moving device;
the method comprising:
operating the air moving device to extract air from the internal space;
passing the extracted air through the filtering element to remove at least one contaminant from the extracted air;
returning the extracted filtered air to the internal space; and
controlling the speed of the air moving device to minimize the speed of the air moving device while maintaining the predetermined air quality in the internal space.

2. The method as recited in claim 1, wherein the air handling system comprises a fresh air intake operatively connected to the inlet of the air moving device, the fresh air intake providing a fresh air flow, and wherein the method further comprises minimizing the fresh air flow required to maintain the predetermined air quality.

3. The method as recited in claim 1, wherein operating the air moving device comprises substantially continuously operating, and wherein controlling the speed of the air moving device comprises substantially continuously controlling.

4. The method as recited in claim 1, wherein the filtering element comprises an optimum face velocity, and wherein controlling the operation of the air moving device further comprises controlling the filtering element air face velocity to substantially the optimum face velocity.

5. The method as recited in claim 2, wherein the fresh air flow required to maintain the substantially predetermined air quality in the room is at least 20% lower than the fresh air flow required when not controlling the operation of the air moving device.

6. The method as recited in claim 2, wherein the fresh air flow required to maintain the substantially predetermined air quality in the room without continuously controlling the operation of the air moving device is about 15 cubic feet per minute per person, and wherein the fresh air flow required to maintain the substantially predetermined air quality in the room while controlling the operation of the air moving device is about 7 cubic feet per minute per person.

7. The method as recited in claim 1, wherein the air handling system further comprises a sensor adapted to detect a constituent of the air in the internal space, and wherein controlling the operation of the air moving device comprises controlling the operation of the air moving device in response to the sensor.

8. The method as recited in claim 1, wherein the predetermined air quality comprises a predetermined level of one or more of cigarette smoke, pollen, mold, mildew, viruses, bacteria, and odor.

9. A system for providing a predetermined air quality in an internal space, the system comprising:
an air-moving device having an inlet in fluid communication with air in the internal space and an outlet in fluid communication with the internal space;
a filtering element adapted to remove at least one contaminant from an air flow passing through the filtering element, the filtering element in fluid communication with one of the inlet and the outlet of the air moving device;
a speed controller adapted to control the speed of the air moving device to minimize the speed of the air moving device while maintaining the predetermined air quality in the internal space.

10. The system as recited in claim 9, wherein the system further comprises a fresh air intake operatively connected to the inlet of the air moving device, the fresh air intake providing a fresh air flow, and wherein the speed controller is further adapted to minimize the fresh air flow.

11. The system recited in claim 9, wherein the speed controller is adapted to substantially continuously control the speed of the air moving device.

12. The system recited in claim 10, wherein the fresh air flow air required to maintain the substantially predetermined air quality in the room is reduced by at least 20% compared to the fresh air flow required without a speed controller.

13. The system recited in claim 10, wherein the fresh air flow required to maintain the substantially predetermined air quality in the room without the speed controller for the air moving device is about 15 cubic feet per minute per person, and wherein the fresh air flow required to maintain the substantially predetermined air quality in the room with the speed controller for the air moving device is about 7 cubic feet per minute per person.

14. The system as recited in claim 9, wherein the predetermined air quality comprises a predetermined level of one or more of cigarette smoke, pollen, mold, mildew, viruses, bacteria, and odor.

15. A method for filtering at least one contaminant from air in a room, the method using an air handling system comprising:
an air moving device comprising one of a fan and blower, the air moving device having an inlet in fluid communication with the air in the room and an outlet;
a non-ionizing, polarized filtering element adapted to remove at least one contaminant from an air flow passing through the filtering element;
a fresh air intake operatively connected to the inlet of the air moving device, the fresh air intake providing a fresh air flow; and
an automated controller for controlling the speed of operation of the air moving device;
the method comprising:
operating the air moving device to extract air from the room;
passing the extracted air through the filtering element to remove at least one contaminant from the extracted air;
drawing the fresh air flow into the system;
returning the filtered extracted air and fresh air flow to the room; and
controlling the speed of the air moving device to minimize the speed of the air moving device and minimizing the amount of fresh air flow introduced to the system.

16. A system for filtering at least one contaminant from air in a room, the system comprising:
a filtering element adapted to remove at least one contaminant from a flow of air passing through the filtering element;
an air moving device adapted to draw at least some air from the room and pass the air through the filtering element; and
means for controlling the operation of the air moving device to vary the flow of the air through the filtering element to optimize the removal of the at least one contaminant from the flow of air.

17. The system as recited in claim 16, wherein the at least one contaminant comprises one or more of cigarette smoke, pollen, mold, mildew, viruses, bacteria, and odor.

18. The system as recited in claim 16, wherein the filtering element comprises a non-ionizing, polarized filtering element.

19. The system as recited in claim 16, wherein the air moving device comprises one of a fan, a blower, and a pump.

20. The system as recited in claim 16, wherein the filtering element comprises an ideal face velocity, and wherein the means for controlling the operation of the air moving device further comprises means for controlling the face velocity of the filter element to substantially the ideal face velocity.

21. The system as recited in claim 16, wherein the air moving device adapted to pass the air through the filtering element comprises an air moving device adapted to one of draw and propel air through the filtering element.

22. The system as recited in claim 16, wherein the system comprises a stand-alone system having a housing adapted to contain the filtering element, the air-moving device, and the means for controlling.
